(19) United States
(12) Patent Application Publication
(10) Pub. No.: US 2002/0085842 A1
(43) Pub. Date: Jul. 4, 2002

(54) Apparatus and method for recording on a black & white film information comprising a pattern of coloured light and apparatus and method for reconstructing from a black & white image such information

(76) Inventors: Kjell Palmius, Berkel-Enschot (NL); Yuzo Toda, Goirle (NL)

Correspondence Address: MERCHANT & GOULD PC, P.O. BOX 2903, MINNEAPOLIS, MN, 55402-0903, US

(21) Appl. No.: 10/007,916

(22) Filed: Nov. 7, 2001

(30) Foreign Application Priority Data
Nov. 8, 2000 (EP) 00203935.2

(51) Int. Cl. G03B 33/00

(52) U.S. Cl. 396/305

(57) ABSTRACT

The invention relates to an apparatus for recording on a black & white photographic film information representing a pattern of coloured light, wherein the apparatus comprises at least a housing with an opening through which, during use, the coloured light enters the housing, wherein the housing comprises within the housing a substantially plane-like position which is, during use, occupied by the black & white film, wherein the apparatus further comprises a mask positioned in a light path extending from the opening to the plane-like position, wherein the mask comprises at least one set of colourfilters, wherein each set comprises at least two colourfilters having different predetermined wavelength transmission characteristics. The invention also relates to a method for recording on a black & white photographic film information representing a pattern of coloured light. The invention further relates to an apparatus for reconstructing from a black & white image information representing a pattern of coloured light. The invention also relates to a method for reconstructing from a black & white image information representing a pattern of coloured light.

The invention relates to an apparatus for recording on a black & white photographic film information representing a pattern of coloured light, wherein the apparatus comprises at least a housing with an opening through which, during use, the coloured light enters the housing, wherein the housing comprises within the housing a substantially plane-like position which is, during use, occupied by the black & white film, wherein the apparatus further comprises a mask positioned in a light path extending from the opening to the plane-like position, wherein the mask comprises at least one set of colourfilters, wherein each set comprises at least two colourfilters having different predetermined wavelength transmission characteristics

The invention also relates to a method for recording on a black & white photographic film information representing a pattern of coloured light.

The invention further relates to an apparatus for reconstructing from a black & white image information representing a pattern of coloured light.

The invention also relates to a method for reconstructing from a black & white image information representing a pattern of coloured light.

An apparatus of the type mentioned in the preamble of conclusion 1 is known from U.S. Pat. No. 3,715,461. In this document the use of a mask is disclosed for recording onto a black & white photographic film information representing a pattern of coloured light.

The background of this technique is related to the differences in costs between use of colour photography and black & white photography.

In conventional colour photography, the photographic film contains several types of silverhalide emulsion layers wherein each layer is sensitive to exposure of either blue, green or red light. Accordingly, several types of expensive components like scavenging agents, couplers and sensitising and dyes are needed during manufacturing of such a film. The manufacturing and developing of such a colour photographic film involves thus a complicated method. In relation to this, not only the film itself is expensive, but also the processing turns out to be a costly event. Since the black & white photographic film does not require any coupler nor any scavenging agent but has an additional advantage in that it only contains one silver halide emulsion layer, the manufacturing and processing of this film is relatively simple and inexpensive in comparison to the manufacturing of the conventional colour film. In conventional black & white photography, a photographic film, containing a silver halide emulsion coated on a transparent film support, is exposed to an image, for example, a pattern of coloured light. This produces a latent image (pattern) within the emulsion layer. The film is then photographically processed to transform the latent image into a silver image which is a negative image of the object photographed. The resulting processed photographic film element, the negative image, is then placed between a uniformly exposing light source and a black & white photosensitive paper. A black & white photographic print is then obtained. The original pattern of coloured light is, in this case, reduced to a pattern of grey intensities.

It has been a challenge to develop a technique for recording on a black & white film information representing a pattern of coloured light, in such a way, that the technique allows for reconstructing the information representing a pattern of coloured light from a black & white image. To this end, the method described in U.S. Pat. No. 3,715,461 uses the earlier mentioned mask which is placed atop the black & white film such that the mask masks the photosensitive side of the film. The mask comprises a plurality of sets of three colour filters. In each set, a first colour filter only transmits a blue wavelength range, a second colour filter only a green wavelength range, and a third colour filter only a red wavelength range. In use, the pattern of coloured light is projected onto the mask. The light exiting the mask is composed of spatially separated red light beams, green light beams and blue light beams. As the colour filters are, according to U.S. Pat. No. 3,715,461, line-shaped, exposure of the black & white film by the light exiting the mask as described, finally results in a pattern of grey-lines on the black & white film. The grey-intensity may vary along the longitudinal direction of each line as a result of varying colour intensities in the original pattern of coloured light. Due to the differently coloured light beams exiting the colour filters, the grey-intensity may also vary from line to line. As the intensity transmittance of colourfilters only transmitting the blue wavelength range, is more then for filters only transmitting the green wavelength range, which is, on its turn, more then the intensity transmittance for the colourfilters which only transmit the red wavelength range, each specific colourfilter has, according to U.S. Pat. No. 3,715,461, a different width of respectively 25, 35 and 40% of the total width of each set wherein each set comprises a blue, a green and a red filter. The differences in width is intended to compensate for the differences in transmitted intensity. The differences in width for each filter is also mentioned to be used for detecting the location of each colourfilter, as the width corresponds to the transmitted wavelength range. The width is in this sense an identification mark of the wavelength transmission chracteristics of the colourfilter. By scanning the film point by point and determining the (relative) width of the lines (a process which is not clearly disclosed in U.S. Pat. No. 3,715,461), the information comprising a pattern of coloured light, is reproducable from the black & white film after conversion of a measured grey intensity at a scannned position into the predetermined colourrange which corresponds to the width of the scanned grey line. Further electronic treatment and the use of a colour laser or a TV enables production of the original pattern of coloured light.

A disadvantage of the mask comprising colourfilters with different widths as disclosed in U.S. Pat. No. 3,715,461 is that the contribution of the red beam to the recorded pattern is spatially high in comparison to the contribution of the green beam. The contribution of the green beam to the recorded pattern is, on its turn, spatially high in comparison to the contribution of the blue beam. In other words the intended compensation for the differences in intensity transmittance leads to unequal spatial contributions to the recording of the pattern of coloured light, for which no simple correction is proposed. The unequal spatial contributions of the three differently coloured beams result in a systematic error in the information representing the pattern of coloured light as recorded onto the black & white film. Consequently, the reconstructed information representing a pattern of coloured light is similarly suffering from such a systematic error.

Another disadvantage of this system is that as the difference in width of the lines is used for recognising the colour of the filter, it is not possible to improve the resolution by minimising the width of each filter. The resolution is determined by the minimum distance between two centres of area's which can contain different information in terms of colourwavelength range and intensity. The resolution in this context is defined such that the resolution increases as this minimum distance decreases. In the mask known from U.S. Pat. No. 3,715,461, the width of two colourfilters always need to be larger than the minimum width possible for a colourfilter.

The invention aims to provide an improved apparatus for recording on a black & white film information representing a pattern of coloured light.

To this end, the apparatus according to the invention is characterised in that the mask further comprises separate from and in addition to the at least one set of colourfilters at least one identification mark which is projectable onto the black & white film, wherein the position of the at least one identification mark corresponds according to a predetermined relationship with the position of at least one set and/or with the position of at least one colourfilter. This has the advantage that the colour filters are, apart from filtering light, not necessarily also used as identification mark with the result that an alteration of the at least one identification mark not necessarily affects the colourfilters and that an alteration of the colourfilters not necessarily affects the at least one identification mark.

According to a preferred embodiment the apparatus according to the invention is characterised in that the at least one set is rectangular. This has the advantage that the design of the mask, the scanning of the black & white image for reconstructing the information and the reconstruction itself can be done according to simple patterns.

According to a more preferred embodiment the apparatus according to the invention is characterised in that the at least two colourfilters are line-shaped running across the mask in a direction parallel to the longitudinal direction of the at least one set. This allows for further simplifying the design of the mask, the scanning of the black & white image for reconstructing the information and the reconstruction itself.

A much preferred embodiment according to the invention is characterised in that each colourfilter has an equal width extending perpendicular to the longitudinal direction of the colourfilter. This has the advantage that the differently coloured light beams exiting the mask spatially contribute equally to the information representing the pattern of coloured light. The recorded information is not suffering from a systematic error as a result of spatially unequal distributions of differently coloured beams.

A very much preferred embodiment of the apparatus according to the invention is characterised in that the mask comprises a plurality of sets of colourfilters. This offers the advantage that the pattern to be recorded can be recorded with an improved resolution in comparison to recording with a mask comprising only one set of colourfilters. This embodiment is especially suitable for recording information representing a complex pattern of coloured light. With a minimum width for the colourfilters it is furthermore possible to achieve excellent resolution.

A method for recording on a black & white photographic film information representing a pattern of coloured light, is characterised in that an apparatus according to any of the claims 1-20 is employed, wherein the method comprises the following steps a) the black & white film is positioned in the housing such that the black & white film occupies the plane-like position; b) the pattern of coloured light enters an opening in the housing and is projected onto the mask; c) the light is transmitted through the colour filters; d) the light as transmitted through the colourfilters is projected onto a black & white film and e) the at least one identification mark is exposed to light such that the identification mark is projected onto the black & white film.

An apparatus for reconstructing from a black & white image information representing a pattern of coloured light as recorded on a black & white film by employment of an apparatus according to any of the claims 1-20, wherein the apparatus for reconstructing comprises a scanner for scanning the black & white image on the film or on a processed version of the film, wherein the scanner is arranged to carry out grey-intensity measurements as a function of scan-positions, wherein the apparatus further comprises means for recognising as a function of a scan-position the at least one identification mark which is present on the black & white image, wherein the apparatus is further arranged to convert, based on the scan-position of the at least one identification mark, the grey-intensities as measured as a function of the scan-positions into a predetermined colourrange intensity.

A method for reconstructing from a black & white image as recorded on a black & white film by applying an apparatus according to any of the claims 1-20, information representing a pattern of coloured light, wherein the method is carried out by employment of an apparatus according to any of the claims 23-27, wherein the method comprises the following steps: a) scanning the black & white image and measuring as a function of scanposition grey-intensities; b) recognising as a function of scan-positions the at least one identification mark which is present on the black & white image; c) converting, based on the scan-position of the at least one identification mark, the grey-intensity as measured as a function of the scanposition into a predetermined colourrange intensity.

### BRIEF DESCRIPTIONS OF THE DRAWINGS

The above mentioned aspects and other embodiments of the invention are described in detail in conjunction with the accompanying drawing. Herein shows:

FIG. 1 a schematic diagram of an apparatus according to the invention for recording on a black & white photographic film information comprising a pattern of coloured light;

FIG. 2 a schematic diagram of a mask according to the invention and a black & white film;

FIG. 3 a schematic cross section of a first embodiment of a mask according to the invention placed atop a photographic black & white film;

FIG. 4 a schematic cross section of a second embodiment of a mask according to the invention placed atop a photographic black & white film;

FIG. 5 a schematic cross section of a third embodiment of a mask according to the invention placed atop a black & white photographic film

FIG. 6 a schematic cross section of a fourth embodiment of a mask according to the invention placed atop a black & white photographic film;

FIG. 7 a top view of an embodiment of a mask according to the invention;

FIG. 8 a top view of an alternative embodiment of a mask according to the invention;

FIG. 9 a schematic diagram representing a method according to the invention for reconstructing from a black & white image information comprising a pattern of coloured light.

### DETAILED DESCRIPTION OF THE INVENTION

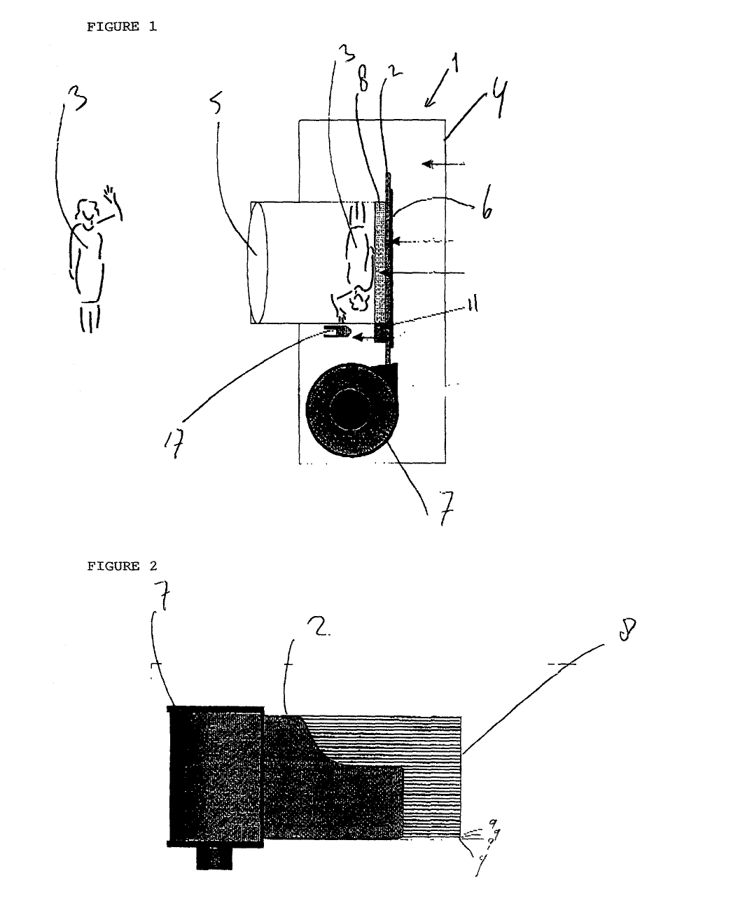

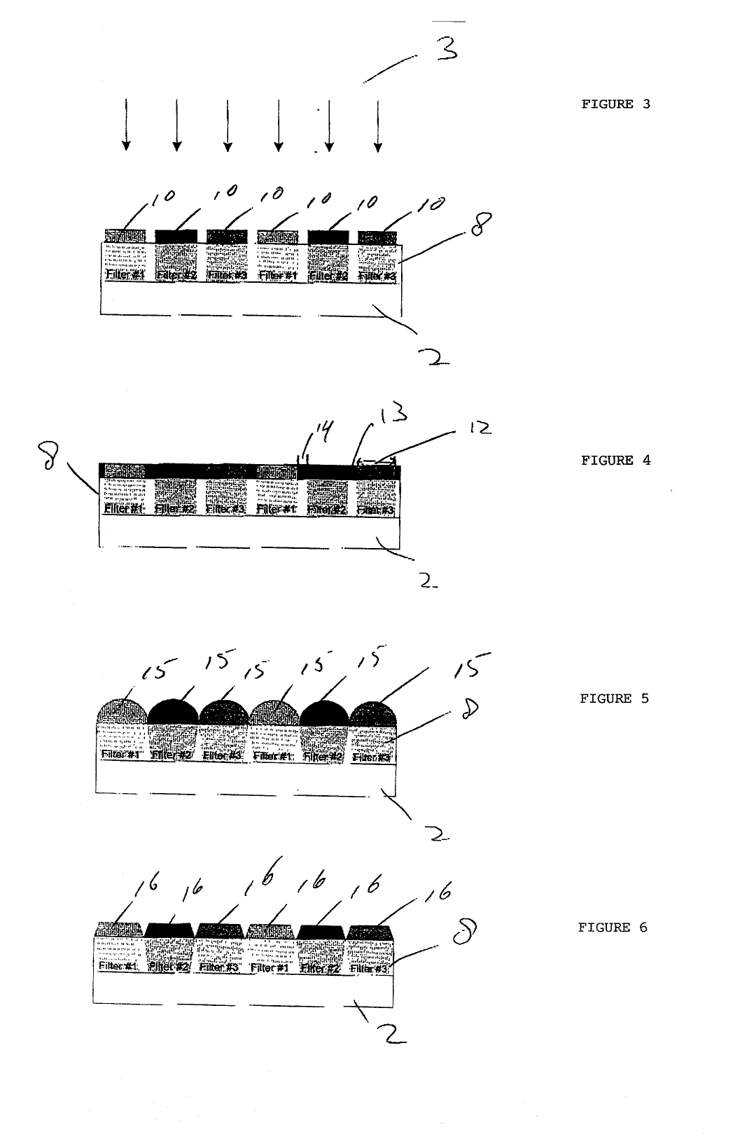

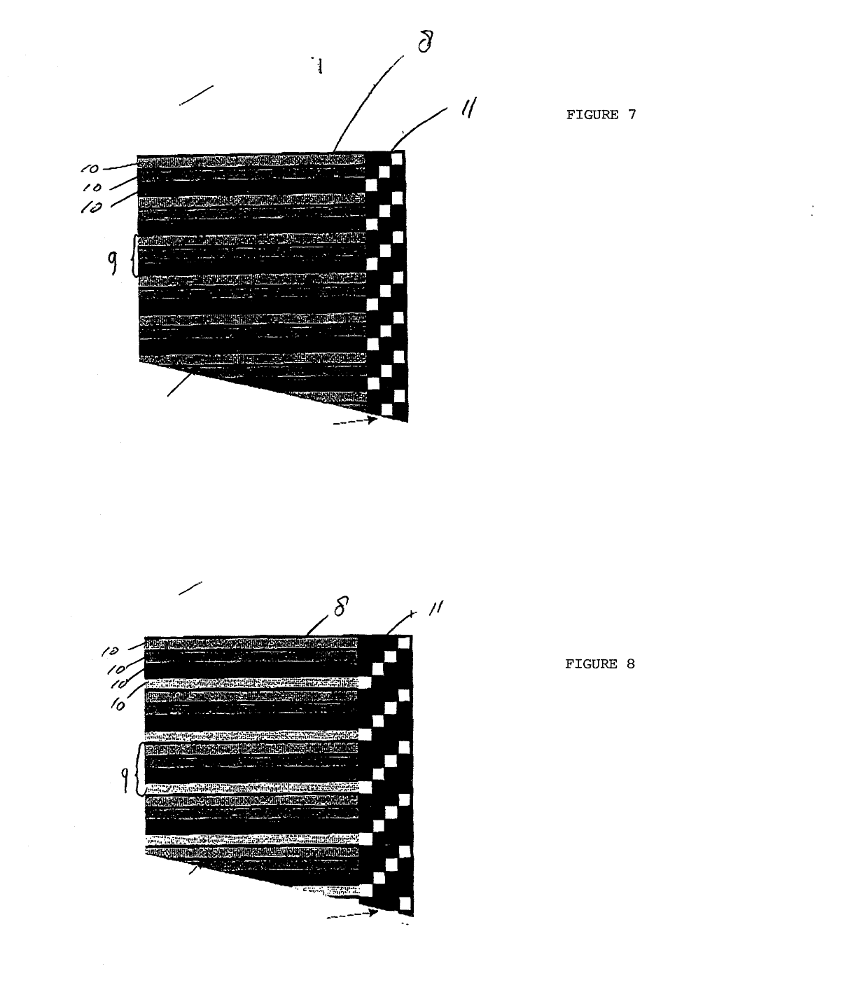

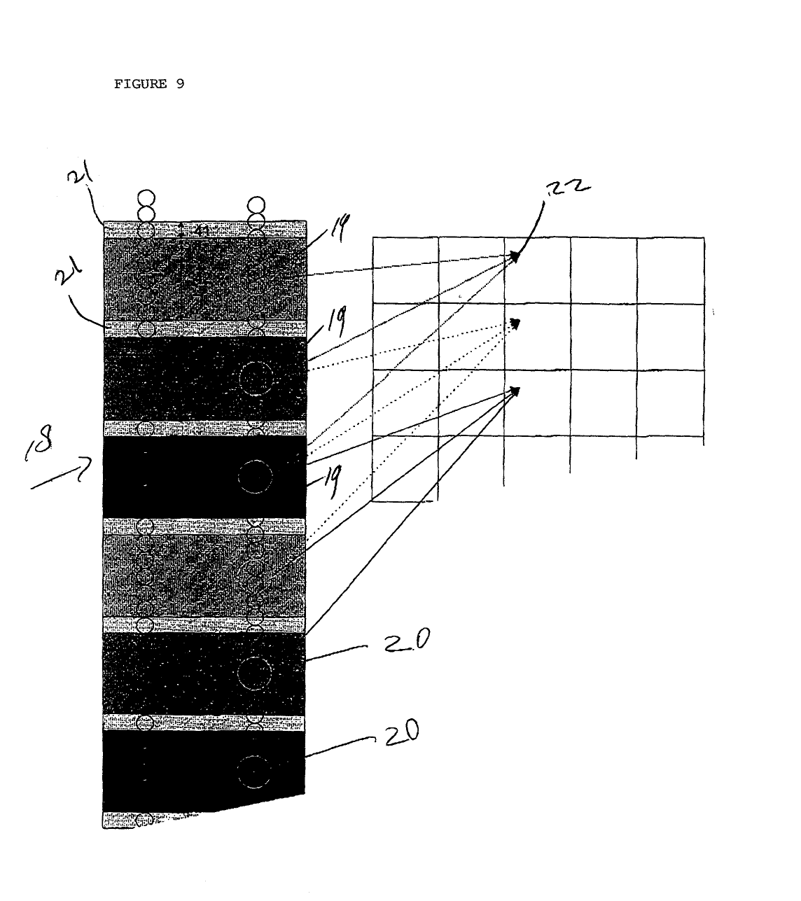

FIG. 1 shows an apparatus 1 for recording on a black & white photographic film 2 information comprising a pattern of coloured light 3. The apparatus comprises a housing 4 with an opening 5 through which, during use, the coloured light 3 enters the housing 4. The housing 4 comprises within the housing 4 a substantially plane-like position 6 which is, during use, occupied by the black & white film 2. The black & white film 2 is usually stored in a film cassette 7. The apparatus 1 comprises a mask 8 positioned in a light path extending from the opening 5 to the plane-like position 6. The mask 8 as shown in FIG. 2, comprises a plurality of substantially rectangular sets 9 of colourfilters 10 extending across the mask 8. It is, of course, equally possible that the mask comprises only one set of colourfilters. Each set 9 comprises a three line-shaped colourfilters 10, each having mutually different wavelength transmission characteristics, (see FIG. 3). Preferably a first colourfilter out of the three line-shaped colourfilters has red wavelength transmission characteristics, a second one has green wavelength transmission characteristics and a third one has blue wavelength transmission characteristics. The colourfilters 10 run across the mask 8 in a direction parallel to the longitudinal directions of the rectangular sets 9. The mask 8 further comprises, in addition to and separate from the line-shaped colourfilters 10, a plurality of identification marks 11 which are projectable onto the black & white film 2 as shown in FIG. 7. The identification marks 11 correspond according to a predetermined relationship with the subsequent positions of the sets 9 and/or the colourfilters 10. Although in the example as drawn many identification marks 11 are shown, it is also possible to have only one mark 11. In the case of one mark 11 the position of the mark 11 indicates the predetermined position of each set 9. If the sets are identical, then also the position of each colourfilter 10 is fixed. In the cross-sectional view of the mask 8 (in FIG. 3) each colourfilter 10 has an equal width 12 extending perpendicular to the longitudinal direction of the colourfilter 10. The width 12 of each colourfilter 10 is preferably less than 50 micrometer. Even better would be a width 12 of each colourfilter equal to less than 20 micrometer. Ideally, the width 12 of each colourfilter 10 is less than 5 micrometer. The width 12 corresponds, in this case, roughly with at least two times the size of a silverhalide grain. A preferred embodiment of the mask 8 is shown in FIG. 4 wherein the mask comprises between each pair of colourfilters 10 at least one separating line 13. Due to the separating lines 13, mixing of light transmitted by neighbouring colourfilters 10 is prevented. For reasons elsewhere explained in this description, the separating lines 13 may also be called tracking lines. The width 14 of the separating line 13 equals about 15 to 25 percent of the width 12 of a colourfilter 10. The cross-sectional shape of the line shaped colourfilter 10, is in a preferred embodiment in FIG. 5 such that the incoming light traverses a convexly shaped lens 15 with the result that light exiting the mask converts to a smaller area on the black & white film 2. This also prevents mixing of light on the black & white film 2 and may, due to the converting beams have a similar effect on the black & white film 2 as the presence of the separating lines 13 on the mask 8 have. A variation on the convex shape is shown in FIG. 6 where the cross sectional shape of the line-shaped colourfilters 10 correspond to a trapezium 16. FIG. 7 shows a top view of a mask 8 according to the invention. Mask 8 comprises three different colourfilters 10. Through each colourfilter 10 either a red wavelength range is transmittable, a green wavelength range or a blue wavelength range is transmittable. An alternative mask 8 comprises four colourfilters 10, each having mutually different wavelength transmission characteristics, as shown in FIG. 8. It will be clear from the FIGS. 1-6, that the method for recording on a black & white photographic film 2 information comprising a pattern of coloured light 3 wherein a apparatus 1 is employed, comprises the following steps: a) the black & white film 2 is positioned in the housing 4 such that the black & white film 2 occupies the plane-like position 6; b) the pattern of coloured light 3 enters an opening 5 in the housing 4 and is projected onto the mask 8; c) the light is transmitted by the colour filters 10; d) the light as transmitted through the colourfilters 10 is projected onto a black & white film 2 and e) the at least one identification mark 11 is exposed to light such that the identification mark 11 is projected onto the black & white film 2. 1. For step d), light entering the housing 4 can be used, but preferably the apparatus 1 for recording on a black & white photographic film 2 information representing a pattern of coloured light 3, comprises, for this purpose, a Light Emitting Device (LED) 17 as shown in FIG. 1. A result of a method for recording black & white photographic film 2 information representing a pattern of coloured light 3, is shown in FIG. 9. The black & white film 18 carrying information representing a pattern of coloured light, contains various lines 19 with different grey-intensities. Equally coloured lines 21, usually either fully black & white due to respectively full exposure or no exposure to light, are due to the separating lines 13 on the mask 8. With an apparatus (not shown) for reconstructing information representing a pattern of coloured light as recorded on a black & white film 2, wherein the apparatus comprises a scanner for scanning the black & white image 18, grey intensity measurements are carried out as a function of scanpositions 20. The equally coloured lines 21 may be used as tracking or guidance lines during scanning to ensure that the difference between two adjacent grey lines 19 is more accurately established and/or verified. During scanning the apparatus for reconstructing information representing a pattern of coloured light from a black &white image may furthermore verify and/or more accurately establishes a scanposition 20 as a function of the measured grey-intensity using a difference between the intensity of the equally coloured lines 21 and other grey-intensities on the black & white image 18, wherein the equally coloured lines 21 are due to the presence of separating lines 13 on the mask 8. Suitable scanners (not shown) are well-known and widely available. The apparatus for reconstructing information representing a pattern of coloured light as recorded on a black & white film 2 further comprises means for recognising as a function of the scan-position identification marks 11 which are present on the black & white image 18. These identification marks are not shown on the black & white image 18 in FIG. 9. As described above, the identification marks correspond to positions with a predetermined colourrange of the pattern of coloured light. Means for recognising are widely available and most likely comprise a memory in which the predetermined relationships with respect to positions and colourranges are stored. These means for recognising will further comprise a microprocessor in which signals from the scanner and the memory are combined to generate a signal for conversion of the measured grey-intensities into a predetermined colourrange intensity. The apparatus for reconstructing information representing a pattern of coloured light 3 as recorded on a black & white film 2 is further arranged to convert, based on the scan-position of the at least one identification mark, the grey intensity as measured as a function of the scan-positions 20 into a predetermined colourrange intensity. By taking a set of grey intensity measurements 22 as obtained from scan-positions 20 within an area of the black & white image, and conversion of each grey intensity into a predetermined colouring intensity, a colour of the area within the pattern of coloured light is reconstructed by the apparatus. By subsequently carrying out this process the apparatus is capable of reconstructing the information comprising a pattern of coloured light from the black & white image 18. It is clear that with a reduction of the width 12 of the lines 19 the resolution of the pattern of coloured light will improve. Preferably, the scanner has a scanner resolution such that 50 micrometer is recordable by these two pixels. More in particular the scanner has a scanner resolution such that 20 micrometer is recordable by these two pixels. Ideally, the scanner has a scanner resolution such that 5 micrometer is recordable by these two pixels. This means that one pixel will in any case completely fit within one line with a width equal to 5 micrometer. The apparatus for reconstructing information representing a pattern of coloured light as recorded on a black & white film 2 further comprises means to digitally store and display the information comprising the pattern of coloured light. This allows for further finetuning and manipulation of the image. A method for reconstructing from a black & white image 18 as recorded on a black & white film 2 information representing a pattern of coloured light, wherein the method is carried out by employment of the hereto described apparatus comprises the following steps: a) scanning the black & white image 18 and measuring as a function of scan-position grey-intensities; b) recognising as a function of scan-positions 20 the at least one identification mark 11 which is present on the black & white image 18; c) converting, based on the scan-position of the at least one identification mark 11, the grey-intensity as measured as a function of the scanposition into a predetermined colourrange intensity. Obviously, the colour reconstruction is more accurate if more different lines contribute to the reconstruction. In this respect it is recommended to use a mask comprising a plurality of sets of colourfilters, wherein each set comprises three or four colourfilters 10 having each mutually different wavelength transmission characteristics. It turns out that the reconstruction as described corresponds to a very large extent to a reconstruction carried out by human beings after recording with a naked eye, if the different wavelength characteristics of the colourfilters used in the recording apparatus at least partly overlap. It is furthermore in this respect advantageous if the method for reconstructing from a black & white image 18, information representing a pattern of coloured light 3 comprises means for digitally storing and/or displaying and/or manipulating the converted information representing a pattern of coloured light. Most preferably, in step c) the predetermined colourrange intensity is adjusted as a function of at least two predetermined colourranges. In this case, the at least two predetermined colourranges may correspond, apart from the colourrange under consideration, to the colourranges into which the grey-lines adjacent to the relevant grey-line are converted. In step c) the intensity of the colourrange intensity may further be adjusted as a function of the measured grey-intensities of at least two predetermined scanpositions. In this case, the at least two predetermined grey-intensities may for instance correspond, apart from the intensity under consideration, to grey-lines adjacent to the relevant grey-line. In this process the information in terms of intensity and/or colourrange related to the closest relevant scan-positions may be used, but in addition to this, also the information related to the second closest scan-positions can be taken into account. The earlier mentioned microprocessor will be arranged to convert according to a pre-installed conversion program the intensities. The mask 8 may contain one or more sets 9 of colourfilters 10. In the case of one set 9, the colourfilters 10 may be spaced by a predetermined mutual distance. This distance may for instance refer to the shortest distance between the centres of the colourfilters 10 or to the distance between the colourfilters. Also the separating line 13 may correspond to this distance. In the case of more sets, the sets can be mutually different or all identical. Also the sets 9 may be spaced by a predetermined mutual distance. If the sets 9 are all identical, it may even be that all the colourfilters 10 are spaced by a predetermined mutual distance. Obviously this latter situation results in good resolution of the information representing a pattern of coloured light. Furthermore little memory is needed in the apparatus for reconstructing from a black & white image. To compensate for differences in intensity as transmitted by the mutually different colourfilters 10, the length of the path which the light has to traverse through the filters may be different, although such a compensation is also easily done by the digital means for manipulation of the converted information representing the pattern of coloured light.

It will be understood that the invention is by no means limited to the above described embodiments and examples. Various lenses can be inserted in the light path between the opening 5 in the housing 4 and/or between the mask 8 and the black & white film 2, although it is preferred to minimise the distance between the mask 8 and the black & white film 2. The width of the colourfilters 10 can be as small as possible but is ideally at least twice as large as the size of the silver halide grains in the black & white film. The final resolution of the pattern of coloured light as recorded from a black & white image 18 is determined by the scanresolution and the width of the lines. Reproduction of a colour by combining the intensities of three predetermined colours can be done according to various algorithms. The particular features or a particular mask can be given as input for the apparatus for reconstructing information comprising a pattern of coloured light from a black & white image 18 such that only recognition of one identification mark 11 is sufficient for converting measured grey intensities into predetermined colourrange intensities. Such upgrading schemes and modifications are all understood to fall within the framework of the invention.

1. Apparatus for recording on a black & white photographic film information representing a pattern of coloured light, wherein the apparatus comprises at least a housing with an opening through which, during use, the coloured light enters the housing, wherein the housing comprises within the housing a substantially plane-like position which is, during use, occupied by the black & white film, wherein the apparatus further comprises a mask positioned in a light path extending from the opening to the plane-like position, wherein the mask comprises at least one set of colourfilters, wherein each set comprises at least two colourfilters having different predetermined wavelength transmission characteristics, characterised in that, the mask further comprises separate from and in addition to the at least one set of colourfilters at least one identification mark which is projectable onto the black & white film, wherein the position of the at least one identification mark corresponds according to a predetermined relationship with the position of at least one set and/or with the position of at least one of the colourfilters.

2. Apparatus according to claim 1, characterised in that the at least one set is rectangular.

3. Apparatus according to claim 2, characterised in that the at least two colourfilters are line-shaped running across the mask in a direction parallel to the longitudinal direction of the at least one set.

4. Apparatus according to claim 2 or 3, characterised in that each colourfilter has an equal width extending perpendicular to the longitudinal direction of the colourfilter.

5. Apparatus according to claim 4, characterised in that the width of each colourfilter is less than 50 micrometer.

6. Apparatus according to claim 5, characterised in that the width of each colourfilter is less than 20 micrometer.

7. Apparatus according to claim 6, characterised in that the width of each colourfilter is less than 5 micrometer.

8. Apparatus according to any of the previous claims, characterised in that the at least two colourfilters are spaced by a predetermined mutual distance.

9. Apparatus according to any of the previous claims, characterised in that, the mask comprises between each pair of colourfilters at least one separating line.

10. Apparatus according to any of the claims 8 and 9, characterised in that, the separating line has a predetermined width whereby the distance between the the at least two colourfilters is predetermined.

11. Apparatus according to any of the previous claims, characterised in that, the at least one set contains at least three colourfilters having mutually different wavelength transmission characteristics.

12. Apparatus according to claim 11, characterised in that, a first colourfilter of the at least one set comprises red wavelength transmission characteristics, a second colourfilter of the at least one set comprises green wavelength transmission chracteristics and a third colourfilter of the at least one set comprises blue wavelength transmission characteristics.

13. Apparatus according to any of the previous claims, characterised in that, the at least one set contains at least four colourfilters having mutually different wavelength transmission characteristics.

14. Apparatus according to any of the previous claims, characterised in that at least two of the colourfilters of the at least one set have different wavelength transmission characteristics which at least partly overlap.

15. Apparatus according to any of the previous claims, characterised in that, at least one of the colour filters is shaped such that the light exiting the at least one colour filter converges between the at least one colour filter and the black & white film.

16. Apparatus according to any of the previous claims, characterised in that the apparatus comprises a Light Emitting Device so as to project the at least one identification mark onto the black & white film.

17. Apparatus according to any of the previous claims, characterised in that the mask comprises a plurality of sets of colourfilters.

18. Apparatus according to claim 17, characterised in that the sets are identical

19. Apparatus according to any of the claims 17-18, characterised in that the sets are spaced by a predetermined mutual distance.

20. Apparatus according to any of the claims 8 and 17-19, characterised in that all colourfilters are spaced by a predetermined mutual distance.

21. Mask according to any of the previous claims.

22. Method for recording on a black & white photographic film information representing a pattern of coloured light, wherein an apparatus according to any of the claims 1-20 is employed, wherein the method comprises the following steps a) the black & white film is positioned in the housing such that the black & white film occupies the plane-like position; b) the pattern of coloured light enters an opening in the housing and is projected onto the mask; c) the light is transmitted through the colour filters; d) the light as transmitted through the colourfilters is projected onto a black & white film and e) the at least one identification mark is exposed to light such that the identification mark is projected onto the black & white film.

23. Apparatus for reconstructing from a black & white image information representing a pattern of coloured light as recorded on a black & white film by employment of an apparatus according to any of the claims 1-20, wherein the apparatus for reconstructing comprises a scanner for scanning the black & white image on the film or on a processed version of the film, wherein the scanner is arranged to carry out grey-intensity measurements as a function of scan-positions, wherein the apparatus further comprises means for recognising as a function of a scan-position the at least one identification mark which is present on the black & white image, wherein the apparatus is further arranged to convert, based on the scan-position of the at least one identification mark, the grey-intensities as measured as a function of the scan-positions into a predetermined colourrange intensity.

24. Apparatus according to claim 23, characterised in that the apparatus further comprises means to digitally store and/or display and/or manipulate the converted information representing the pattern of coloured light.

25. Apparatus according to claim 23 or 24, characterised in that the scanner has a scanresolution such that 50 micrometer is recordable by at least two pixels.

26. Apparatus according to claim 25, characterised in that the scanner has a scanresolution such that 20 micrometer is recordable by at least two pixels.

27. Apparatus according to claim 26, characterised in that the scanner has a scanresolution such that 5 micrometer is recordable by at least two pixels.

28. Method for reconstructing from a black & white image as recorded on a black & white film by applying an apparatus according to any of the claims 1-20, information representing a pattern of coloured light, wherein the method is carried out by employment of an apparatus according to any of the claims 23-27, wherein the method comprises the following steps: a) scanning the black & white image and measuring as a function of scanposition grey-intensities; b) recognising as a function of scan-positions the at least one identification mark which is present on the black & white image; c) converting, based on the scan-position of the at least one identification mark, the grey-intensity as measured as a function of the scanposition into a predetermined colourrange intensity.

29. Method according to claim 9 and 28, characterised in that in step a) the scanner verifies and/or more accurately establishes a scanposition as a function of the measured grey-intensities using a difference between the intensity of at least one equally coloured line and other grey-intensities on the black & white image, wherein the at least one equally coloured line is present due to the presence of the at least one separating line on the mask.

30. Method according to any of the claims 28 or 29, characterised in that, the method also comprises digitally storing and/or displaying and/or manipulating the converted information representing a pattern of coloured light.

31. Method according to any of the claims 28-30, characterised in that in step c) the predetermined colourrange intensity is adjusted as a function of at least two predetermined colourranges.

32. Method according to any of the claims 28-31, characterised in that in step c) the intensity of the colourrange intensity is further adjusted as a function of the measured grey-intensities of at least two predetermined scanpositions.
